(19) United States
(12) Patent Application Publication
(10) Pub. No.: US 2008/0176439 A1
(43) Pub. Date: Jul. 24, 2008

(54) SIGNAL CONNECTOR WITH MINIATURIZED PCB-COUPLING MEANS

(75) Inventors: Chao-Jung Chen, Taipei (TW); Chien-Lung Tseng, Taipei (TW); Yi-Lun Wu, Taipei (TW); Shen-Chuan Kao, Taipei (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei (TW)

(21) Appl. No.: 11/870,314

(22) Filed: Oct. 10, 2007

Related U.S. Application Data
(63) Continuation-in-part of application No. 11/377,867, filed on Mar. 16, 2006, now abandoned.

(30) Foreign Application Priority Data
Aug. 24, 2007 (TW) 096214181

(51) Int. Cl. H01R 13/625

(52) U.S. Cl. 439/345

(57) ABSTRACT

A signal connector to be coupled to a circuit board includes a main body for receiving an external signal connector, thereby conducting electric connection between the signal connectors; and a coupling member extending from a front surface of the main body, and having a free end for engaging with a through-hole structure of the circuit board to couple the signal connector to the circuit board; wherein the coupling member extends from the main body in a manner that the coupling member entirely rests on the circuit board while the main body partially or entirely protrudes from the circuit board when the signal connector has been coupled to the circuit board.

### CROSS REFERENCE TO RELATED PATENT APPLICATION

This patent application is a continuation-in-part (CIP) application of a U.S. patent application Ser. No. 11/377,867 filed Mar. 16, 2006 and now pending. The contents of the related patent application are incorporated herein for reference.

### FIELD OF THE INVENTION

The present invention relates to a signal connector, and more particularly to a signal connector to be mounted on a substrate such as a printed circuit board with a miniaturized coupling member.

### BACKGROUND OF THE INVENTION

For extending and diversifying the usage of electronic devices, many peripheral devices are developed. For example, video players (e.g. VCD player, DVD player, etc.) are often connected to TV sets (e.g. CRT, LCD, etc.) for displaying image data stored in video storage media (e.g. VCD, DVD, hard disk, etc.). That is to say, in addition to displaying TV programs, other functions of the TV set can be exhibited through connecting to a peripheral device like a video player. Another well-known example is the usage of the Personal Computer's peripherals such as mice, monitors, keyboards, printers, plotters, and network adapters, etc. These peripherals facilitate the operation of the personal computer and make its function more complete. In most cases, peripherals are physically connected to their master electronic devices through connectors. Electric signals are also transmitted between peripherals and master electronic devices through connectors. Electric connection is built when a plug of a peripheral device is inserted into a compatible socket or jack built in the master electronic device and removed by detaching the plug from the jack. Accordingly, electric current and electronic signals can be transferred or interrupted between the peripheral and the master electronic device. Therefore, the quality of the connector will not only influence the reliability of the power and signal transmission between a peripheral and a master device but also show effect on the operation of the entire master electronic device.

Various connectors are provided for different needs according to different specifications and characters of various electronic devices. These connectors include TNC series coaxial connectors, BNC series RF coaxial connectors, N series RF coaxial connectors, MICROAX (MCX) RF coaxial connectors, sub miniature version A (SMA) RF coaxial connectors, sub miniature version B (SMB) RF coaxial connectors, and sub miniature version C (SMC) RF coaxial connectors, etc. Each of the above-mentioned connectors has its own specific features and applicable frequency range. For satisfying the needs of portability, the electronic devices are designed to be smaller and smaller. Therefore, the connectors are also miniaturized. One of the examples is the development of MMCX (miniature microax) RF coaxial connectors. The MMCX RF coaxial connector can be mounted on the printed circuit board (PCB) by surface mount technology (SMT) such as surface mount soldering or surface mount gluing, and the resulting device can be arbitrarily rotated in 360 degrees. The above-mentioned advantages make the MMCX RF coaxial connectors become the main string among the connectors in the market.

FIG. 1A illustrates a conventional RF connector 10, while FIG. 1B indicates the assembling of the conventional RF connector 1 and the PCB 11. The conventional RF connector 10 has two junction surfaces 101 and 102 on two sides thereof. The conventional RF connector 10 is mounted to the PCB 11 by surface mounting the two junction surfaces 101 and 102 on the PCB 11, for example by soldering or gluing. In order that the junction surfaces 101 and 102 can be soldered or glued on the PCB 11, it is necessary to additionally create a recess 110 in the circuit board 11 for partially embedding the RF connector 10. It thus wastes some area of the circuit board.

For exempting from the laboring for creating the recess, a conventional RF connector with another PCB-coupling configuration is developed, as shown in FIG. 2. The RF connector 20 of FIG. 2 is coupled to a circuit board 21 via a coupling member 201 by way of surface mounting technology (SMT) such as soldering or gluing. Since the RF connector 20 is completely disposed above the circuit board 21, no recess is required for embedding the main body of the RF connector 20. However, the thickness of the assembled device is undesirably increased.

A further problem is encountered with the above conventional connectors. Generally speaking, the strength for plugging into the jack 104 or 204 of a commercialized RF connector 10 or 20 is about 3.4 pounds, while unplugging from the jack 104 needs about 1.4-3.4 pounds of force. Under this circumstance, the life time of the connector would be about 500 times plug/unplug actions. The surface mounting structure is subject to damage by more than 500 times plug/unplug actions. Since a RF connector is typically built in the housing of an electronic device and need not switch plugs frequently, 500-times plug/unplug actions may be satisfactory. However, once the RF connector is exposed from the housing to be used as a terminal socket for users' frequent plug/unplug actions, generally over 500 times, the RF connector may detached from the circuit board. The problem would become even worse if the applied SMT is a non-lead soldering process.

A connector coupled to a circuit board by way of pin attachment as shown in FIG. 3 or 4, instead of surface mounting, may ameliorate the damage problem. The coupling portion of the connector 30 includes two extending arms 301, each of which is secured thereon a couple of attachment pins (not shown) downwardly penetrating through corresponding holes arranged in the circuit board 31. In this way, the plugging/unplugging operations into/from the jack will minimize the damage of the coupling between the connector and the circuit board. The connector as shown in FIG. 4 uses attachment pins in a similar way. That is, the coupling portion of the connector 40 includes two wings 401, each of which is secured thereon a couple of attachment pins (not shown) downwardly penetrating through corresponding holes arranged in the circuit board 41. Since the coupling manner of FIG. 3 sustains against the edge 310 of the circuit board 31 with a shoulder 302 thereof, the main body 300 of the connector 30 does not protrude too much from both surfaces of the circuit board 31. Therefore, the thickness of the assembled device is not increased as much as in the case of FIG. 2. On the other hand, for avoiding undesirable thickness increase of the assembled device of FIG. 4, a recess 410 is created in the circuit board 41 for embedding the main body 400 of the connector 40.

The connectors illustrated in FIG. 3 and FIG. 4, although solving the above-mentioned problems to a certain extent, still suffer from some other problems. For example, the shoulder 302 of the connector 30 protruding from the edge 310 still occupies a certain space rendering the assembled device not compact enough. On the other hand, the wings 401 of the connector 40 may hinder engagement of upper and lower housing parts (not shown) for enclosing the assembled device in a subsequent assembling procedure.

### SUMMARY OF THE INVENTION

Therefore, according to the present invention, an improved connector structure is provided to enhance the reliability of the combination of the connector and the printed circuit board so as to raise resistance to frequent plug/unplug actions.

In another aspect, an improved connector structure according to the present invention is provided, exempting from the need of additional recess in the circuit board where the connector is to be coupled.

Furthermore, an improved connector structure having a miniaturized coupling member and easy to be enclosed with upper and lower housing parts in a subsequent assembling procedure is provided according to the present invention.

According to the present invention, a signal connector to be coupled to a circuit board includes a main body for receiving an external signal connector, thereby conducting electric connection between the signal connectors; and a coupling member extending from a front surface of the main body, and having a free end for engaging with a through-hole structure of the circuit board to couple the signal connector to the circuit board; wherein the coupling member extends from the main body in a manner that the coupling member entirely rests on the circuit board while the main body partially or entirely protrudes from the circuit board when the signal connector has been coupled to the circuit board.

In an embodiment, the circuit board has a recess from an edge thereof for receiving a front section of the main body, and the coupling member laterally and forwardly extends from the front section of the main body to be surface-mounted onto the circuit board beside the recess.

In an embodiment, the coupling member is an arc-shaped structure protruding from the front surface of the main body and having two end teeth for engaging with two through holes of the circuit board, respectively.

In an embodiment, the coupling member is a gate-shaped structure protruding from the front surface of the main body and having two end teeth for engaging with two through holes of the circuit board, respectively.

In an embodiment, the main body includes a jack having therein a signal line structure, and the signal line structure has one end to be electrically connected to the external signal connector and the other end to be inserted into an additional through hole of the circuit board, thereby conducting the external signal connector with the circuit board. On the other hand, the main body further includes a grounding shell structure surrounding the signal line structure and separate from the signal line structure with an insulating spacer plate.

Preferably, the coupling member is electrically insulated from the signal line structure by way of the insulating spacer plate.

Preferably, the coupling member is integrally formed with the grounding shell structure of the main body.

In an embodiment, the coupling member extends from the front surface of the main body in a first direction substantially normal to the front surface, and the free end of the coupling member turns into a second direction in substantially parallel to the front surface of the main body.

Preferably, a width of the coupling member is smaller than that of the front surface in the second direction.

For example, the signal connector can be an audio/video signal or a coaxial cable connector.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a schematic perspective view of a conventional signal connector;

FIG. 1B is a schematic perspective view showing how the connector of FIG. 1A is mounted onto a printed circuit board;

FIG. 2A is a schematic perspective view of another conventional signal connector;

FIG. 2B is a schematic perspective view showing an assembled device of the connector of FIG. 2A onto a printed circuit board;

FIG. 3 is a schematic perspective view showing an assembled device of a further conventional connector onto a printed circuit board;

FIG. 4 is a schematic perspective view showing an assembled device of a still further conventional connector onto a printed circuit board;

FIG. 5A is a schematic perspective view illustrating a structure of a signal connector according to a first embodiment of the present invention; and

FIG. 5B is a schematic perspective view showing how the signal connector of FIG. 5A is mounted onto a printed circuit board;

FIG. 5C is a schematic perspective view showing an assembled device of the connector of FIG. 5A onto a printed circuit board;

FIG. 5D is a schematic side view partially showing an electronic device including the assembled device of FIG. 5C enclosed with upper and lower housings;

FIG. 6A and 6B are schematic perspective views from two directions showing how a signal connector is mounted onto a printed circuit board according to a second embodiment of the present invention;

FIG. 6C and 6D are schematic perspective views from two directions showing an assembled device of the connector of FIG. 6A and FIG. 6B onto the printed circuit board;

FIG. 6E is a schematic side view partially showing an electronic device including the assembled device of FIG. 6C and FIG. 6D enclosed with upper and lower housings;

FIG. 7A and 7B are schematic perspective views from two directions showing how a signal connector is mounted onto a printed circuit board according to a third embodiment of the present invention;

FIG. 7C and 7D are schematic perspective views from two directions showing an assembled device of the connector of FIG. 7A and FIG. 7B onto the printed circuit board;

FIG. 8A and 8B are schematic perspective views from two directions showing how a signal connector is mounted onto a printed circuit board according to a fourth embodiment of the present invention;

FIG. 8C and 8D are schematic perspective views from two directions showing an assembled device of the connector of FIG. 8A and FIG. 8B onto the printed circuit board;

FIG. 9A and 9B are schematic perspective views from two directions showing how a signal connector is mounted onto a printed circuit board according to a fifth embodiment of the present invention;

FIG. 9C and 9D are schematic perspective views from two directions showing an assembled device of the connector of FIG. 9A and FIG. 9B onto the printed circuit board;

FIG. 10A and 10B are schematic perspective views from two directions showing how a signal connector is mounted onto a printed circuit board according to a sixth embodiment of the present invention;

FIG. 10C and 10D are schematic perspective views from two directions showing an assembled device of the connector of FIG. 10A and FIG. 10B onto the printed circuit board;

FIG. 11A and 11B are schematic perspective views from two directions showing how a signal connector is mounted onto a printed circuit board according to a seventh embodiment of the present invention; and

FIG. 11C and 11D are schematic perspective views from two directions showing an assembled device of the connector of FIG. 11A and FIG. 11B onto the printed circuit board.

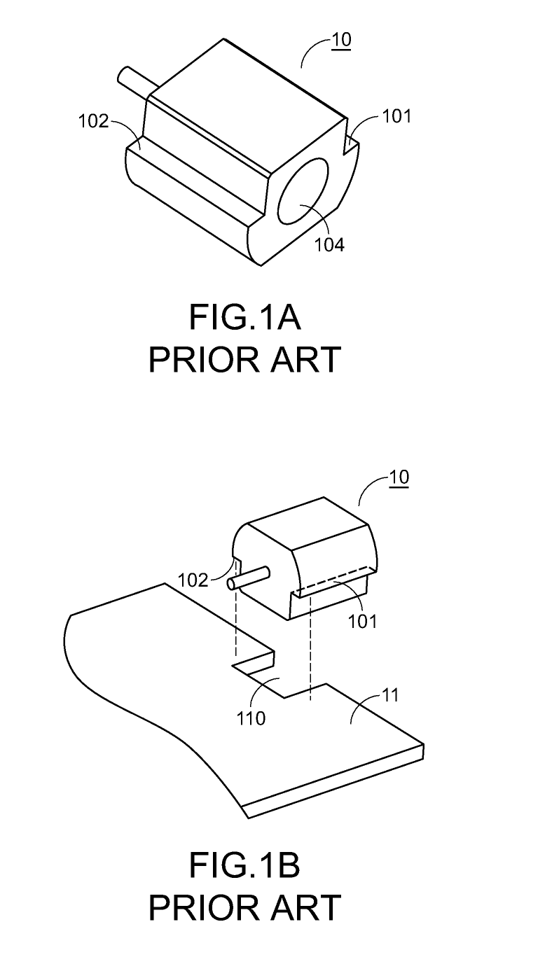

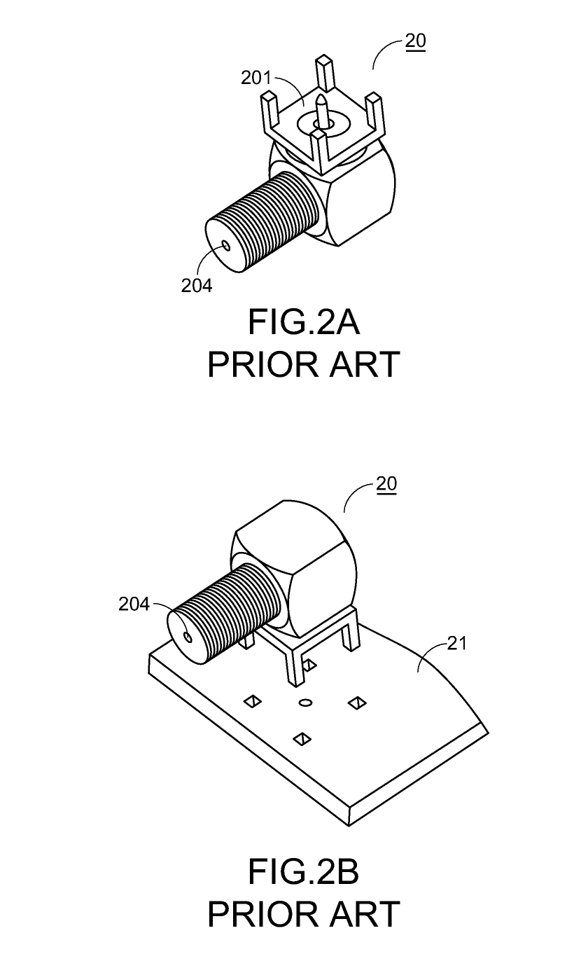

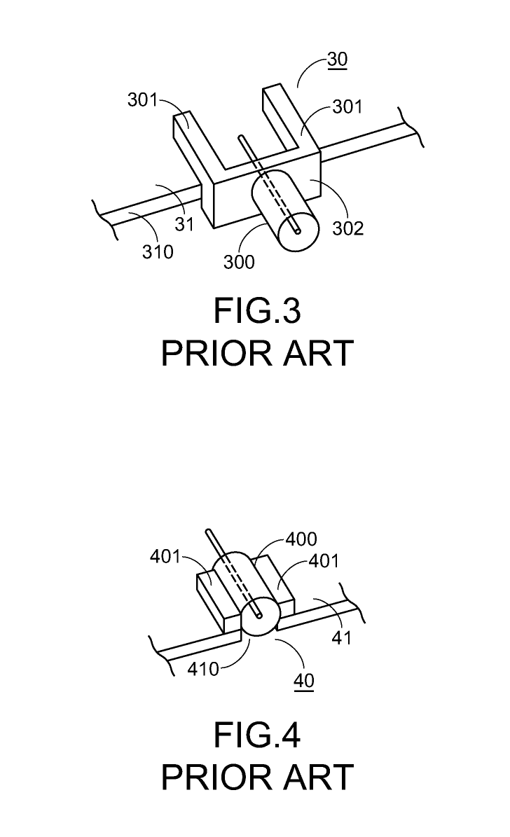

### DETAILED DESCRIPTION OF PREFERRED EMBODIMENTS

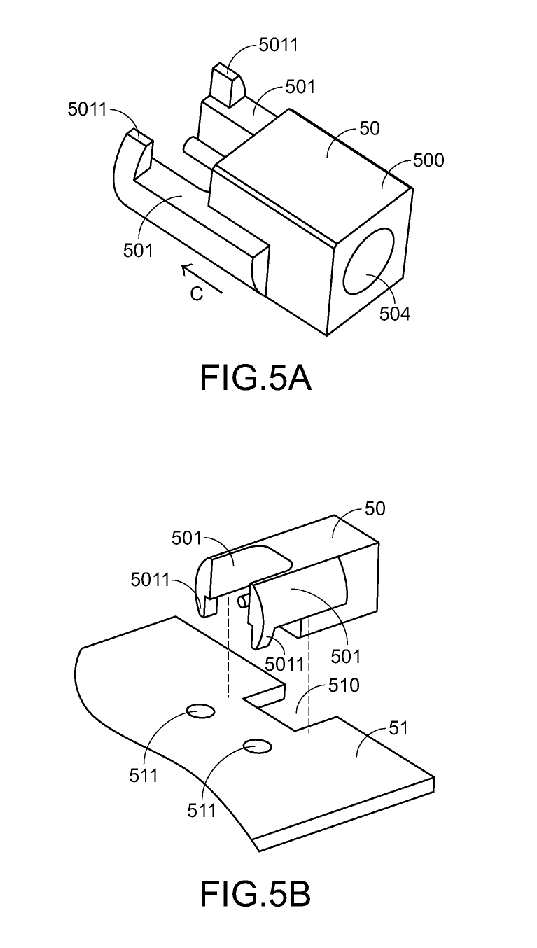

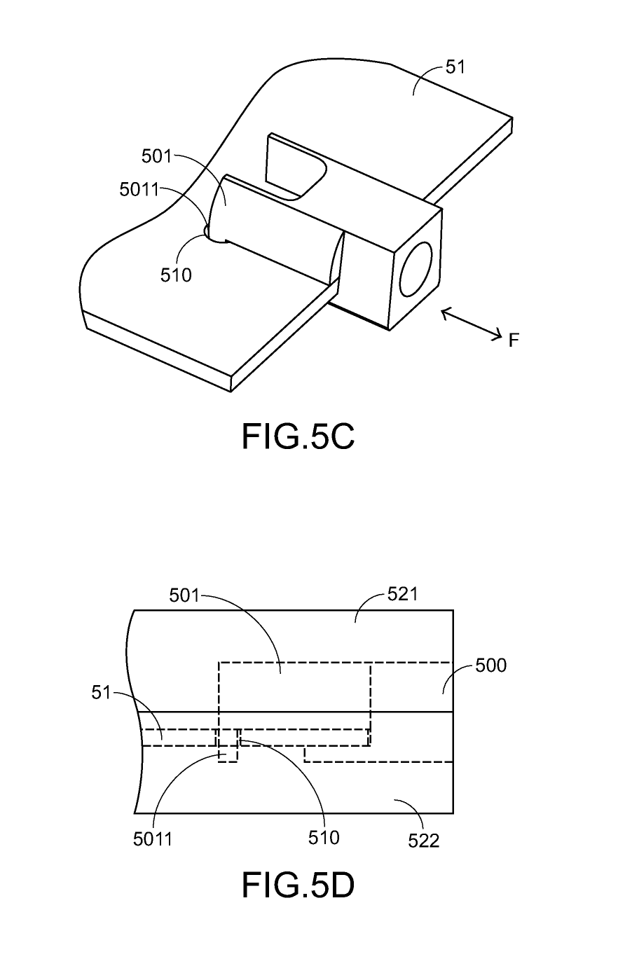

FIGS. 5A˜5D illustrate an electronic device including a printed circuit board (PCB) 51 and a signal connector 50 mounted onto the PCB 51. The connector 50 includes a main body 500, mounting arms 501, coupling pins 5011 and a jack portion 504. The jack 504 is provided for electric connection to a coaxial cable (not shown). The two mounting arms 501 laterally and forwardly extend from the front sections of opposite sides of the main body 500, respectively. The coupling pins 5011, which are preferably but not necessarily integrally formed of a conductive material with the mounting arms 501, protrude from the ends of the mounting arms 501 so as to provide hook structures for the connector 50. The coupling pins 5011 penetrate through and engage with corresponding through holes 511 of the PCB 51, and the bottoms of the mounting arms 501 are seated on and secured to the PCB 51 via suitable means, e.g. surface mount soldering or surface mount gluing, thereby providing further fixing between the connector 50 and the PCB 51.

In this embodiment, the mounting arms 501 are designed to extend from the main body 500 in the direction C parallel to the coaxial-cable plugging/unplugging force F (preferably but not necessarily), and the coupling pins 5011 are designed to protrude from the mounting arms 501 normally (preferably but not necessarily). By way of the engagement of the coupling pins 5011 with the through holes 511 and the surface mounting of the mounting arms 501 to the PCB 51, the connector 50 can be easily and firm-fly mounted to the PCB 51.

Due to the mounting arms 501 laterally and forwardly extend from only the front sections of opposite sides of the main body 500, the coupling means is miniaturized compared to the prior art. In addition, it is thus feasible to have the mounting arms 501 entirely lie on the PCB without extending outside the PCB 51 after assembling as shown in FIG. 5C. In this way, the rear section of the main body 500 will be the only portion protruding from the PCB range. As such, as illustrated in the side view of FIG. 5D, when the assembly of the connector 50 and PCB 51 is enclosed with two pieces of housings, e.g. upper housing 521 and lower housing 522, the opening of the combined housing for exposing the jack 504 need only conform to the configuration of the main body 500 itself without taking the configuration of the mounting arms into consideration. The assembly is relatively compact.

In this embodiment, a recess 510 is created so that the bottoms of the mounting arms 501 may be seated on and secured to the PCB 51 to provide further fixing between the connector 50 and the PCB 51. Nevertheless, the recess 510 is not essential to the present invention. The connector 50 may just rely on the coupling pins 5011 to engage with the through holes 511 so as to be mounted onto the PCB 51.

In this embodiment, the connector 50 is a RF connector such as a MMCX RF coaxial connector, but it can also be MCX, SMA, SMB, SMC or any other micro/miniature connector.

Hereinafter, several embodiments of connectors that do not need recesses to work with are described.

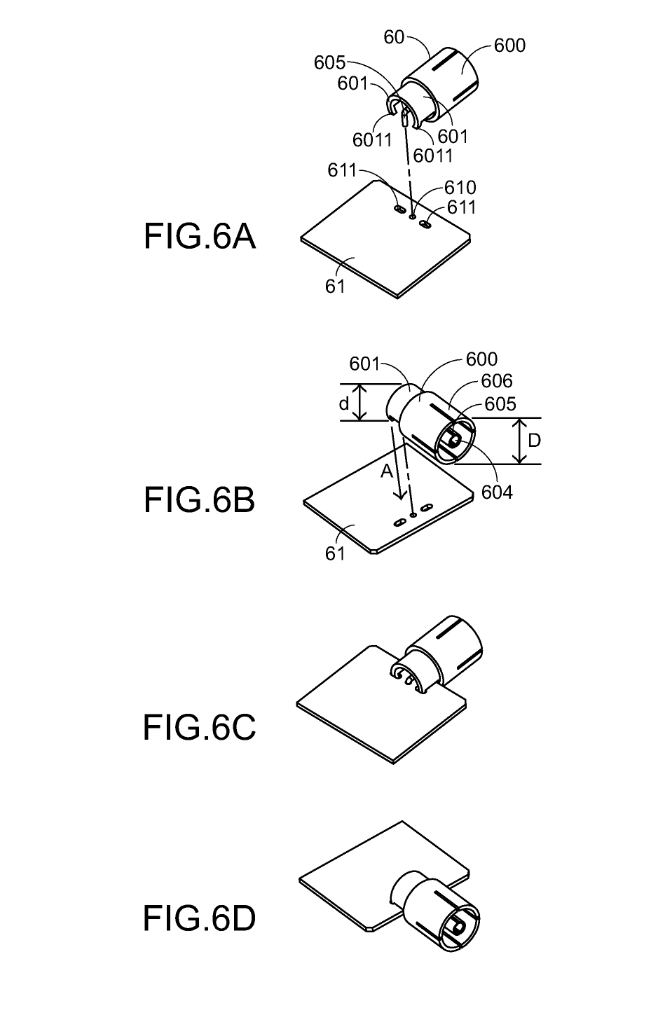

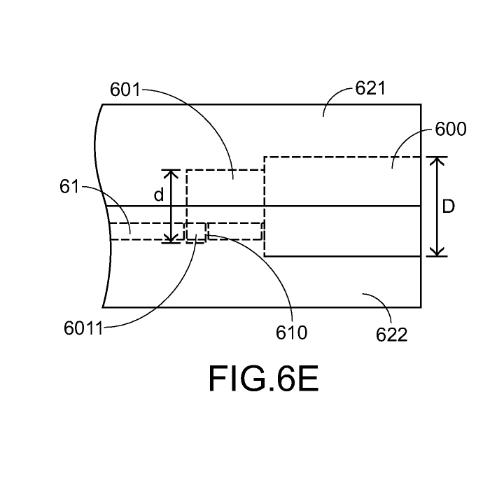

Please refer to FIGS. 6A˜6E. In this embodiment, the connector 60 includes a main body 600 and a coupling member 601 extending from the front side of the main body 600, preferably but not necessarily in a direction normal to the front surface. The coupling member 601 is configured as an arc with two end teeth 6011. The arc 601 has a size preferably but not necessarily smaller than the front surface of the main body 600, i.e. d<D. The end teeth 6011 are turned into a direction in parallel to the front surface of the main body 600 so as to be engageable with corresponding through holes 611 in a PCB 61. With proper conformation of the position of the through holes 611 to the length of the coupling member 601, the coupling member 601 entirely rests on the PCB without extending outside the PCB 61 after assembling as shown in FIG. 6C and 6D. As a result, the connector 60 can be secured onto the PCB 61. Meanwhile, a signal line conductor 605 of the connector 60, which forms a part of a jack 604 to be electrically connected to an external signal connector (not shown) by one end, is inserted into a through hole 610 of the PCB 61 by the other end for electric conduction between the external signal connector and the PCB 61. The coupling member 601 of the connector 60 preferably but not necessarily has a configuration narrower than the main body 600 instead of laterally extending from the sides of the main body. Thus the coupling member is further miniaturized and occupies less area of the PCB 61. Meanwhile, as illustrated in the side view of FIG. 6E, when the assembly of the connector 60 and PCB 61 is enclosed with two pieces of housings, e.g. upper housing 621 and lower housing 622, the opening of the combined housing for exposing the jack 604 need only conform to the configuration of the main body 600 itself. The assembly is relatively compact.

In this embodiment, the connector 60 further includes a grounding shell structure 606 in addition to the signal line structure 605. It is to be noted that the signal line structure 605 and grounding shell structure 606 should be electrically insulated from each other, and coupling member 601 is also electrically insulated from the signal line structure 605. A plastic spacer plate (not shown) disposed between the signal line structure 605 and grounding shell structure 606 can be used for this purpose. The coupling member 601 with the end teeth 6011 is preferably but not necessarily integrally formed of a conductive material with the grounding shell structure 606.

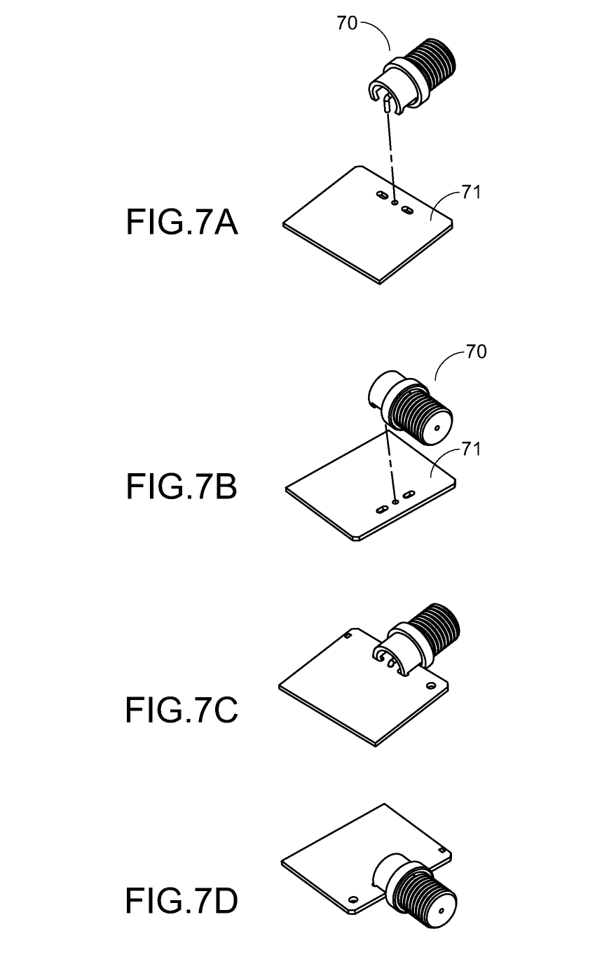

In this embodiment, the connector 60 is an audio/video signal connector. Nevertheless, the connector can also be other kinds of signal connectors such as a coaxial cable connector. FIGS. 7A˜7D illustrate the coupling of a coaxial cable connector 70 to a PCB 71 in a manner similar to that shown in FIG. 6A˜6E.

In this embodiment, the coupling member 601 is arc-shaped. Nevertheless, the coupling member 601 can also have other configurations as long as proper hook structures like the end teeth 6011 can be readily provided to engage with the through holes of the PCB.

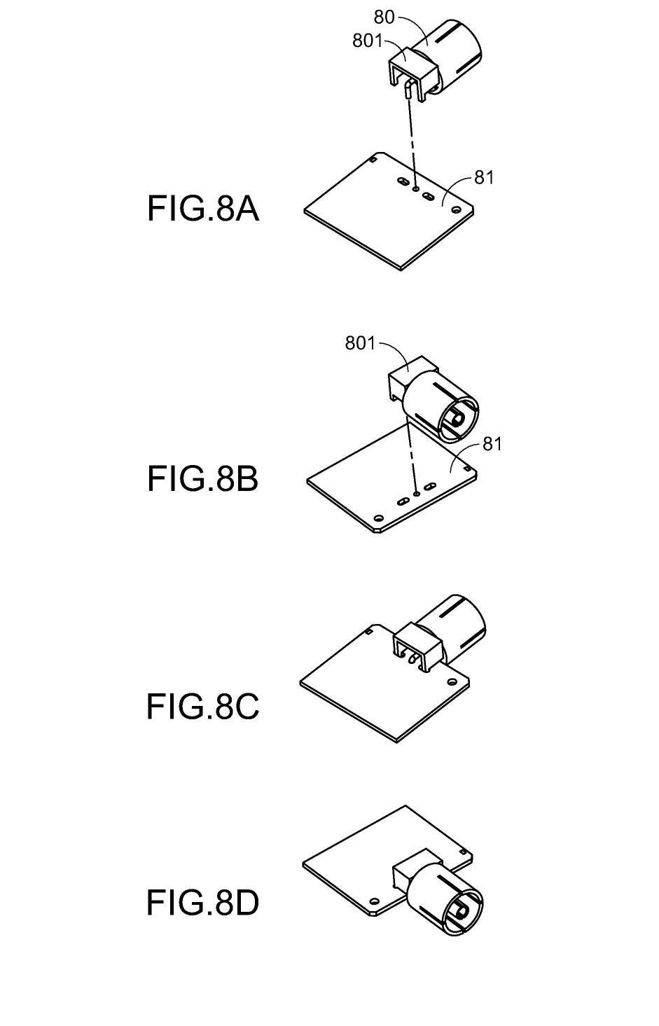

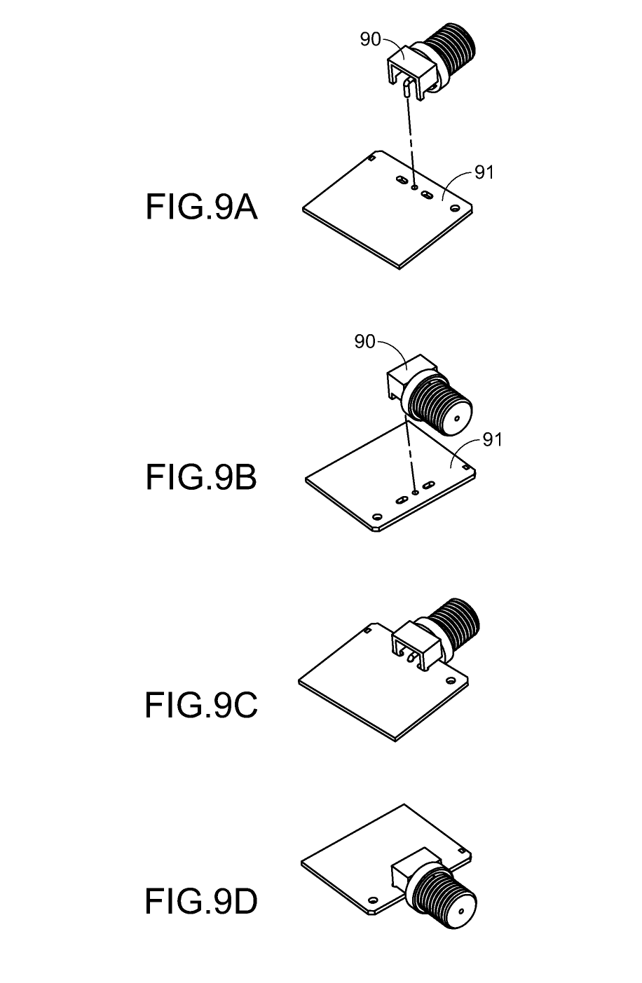

FIGS. 8A˜8D illustrate an audio/video signal connector 80 mounted onto a PCB 81 in a manner similar to that shown in FIG. 6A˜6E, wherein the coupling member 801 of the connector 80 is gate-shaped. Likewise, with such a coupling member, no recess is required, no additional thickness is rendered, and upper and lower housings can be easily manufactured and combined. On the other hand, FIGS. 9A˜9D illustrate the coupling of a coaxial cable connector 90 to a PCB 91 also in a manner similar to that shown in FIG. 6A˜6E.

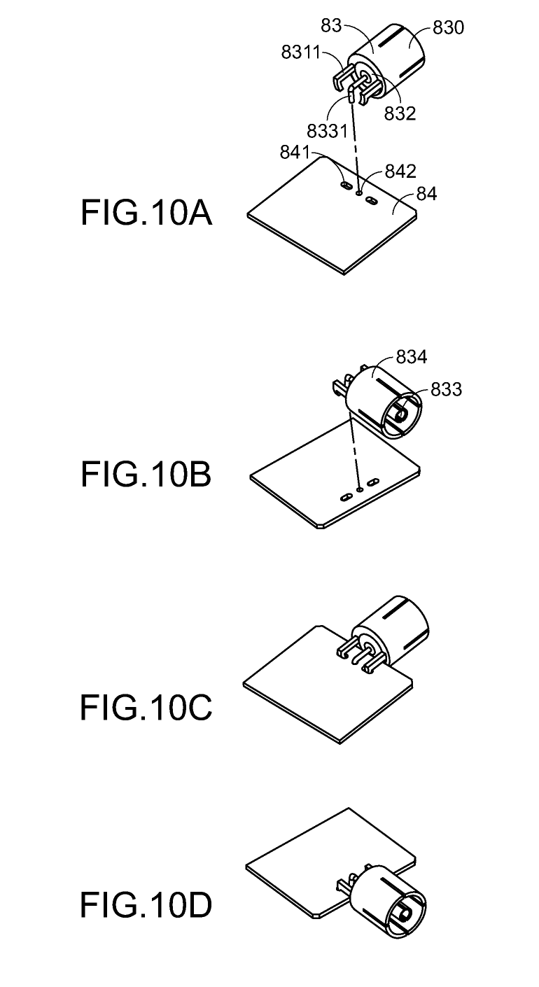

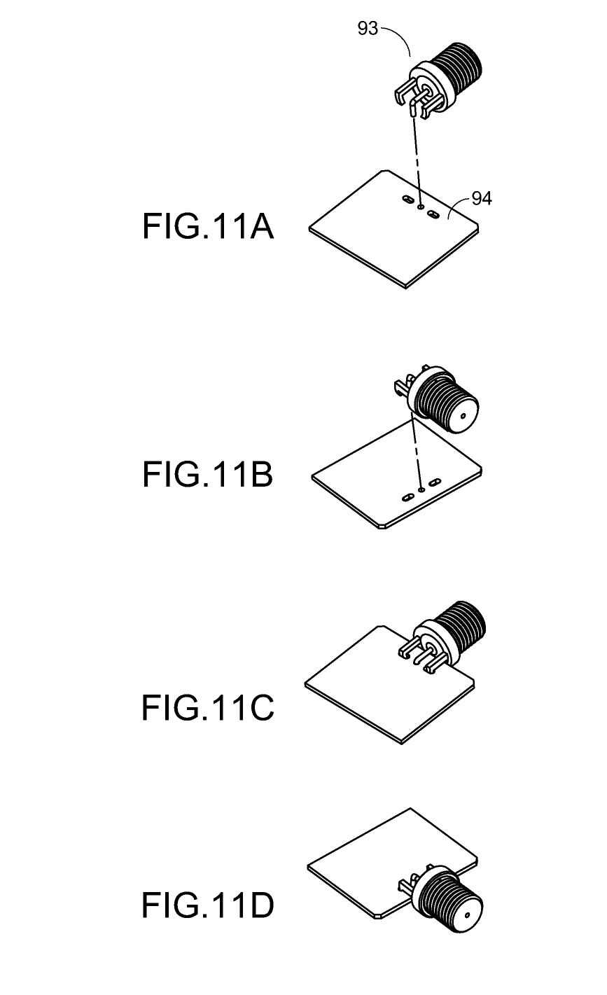

FIGS. 10A˜10D illustrate an audio/video signal connector 83 mounted onto a PCB 84 in a manner similar to that shown in FIG. 6A˜6E, wherein the coupling member of the connector 83 simply includes two hooks 8311 separately protruding from a front surface of the main body 830 to be inserted into corresponding through holes 841 of the PCB. In addition to the hooks 8311, the front surface includes a plastic spacer plate 832 disposed between a signal line structure 833 and a grounding shell structure 834 for electric insulation. A signal line conductor 8331 of the signal line structure 833 penetrates through the plastic spacer plate 832 to be inserted into a corresponding through hole 842 of the PCB 84. Likewise, with such a coupling member, no recess is required, no additional thickness is rendered, and upper and lower housings can be easily manufactured and combined. On the other hand, FIGS. 11A˜11D illustrate the coupling of a coaxial cable connector 93 to a PCB 94 also in a manner similar to that shown in FIG. 6A˜6E.

To sum up, the present invention provides a miniaturized coupling architecture for mounting a signal connector onto a printed circuit board with or without additional recess in the circuit board. In addition, the coupling means has no effect on the overall thickness of the assembled device. Moreover, the enclosing of the assembled device with two pieces of housings can be readily achieved.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A signal connector to be coupled to a circuit board, comprising:
a main body for receiving an external signal connector, thereby conducting electric connection between the signal connectors; and
a coupling member extending from a front surface of the main body, and having a free end for engaging with a through-hole structure of the circuit board to couple the signal connector to the circuit board;
wherein the coupling member extends from the main body in a manner that the coupling member entirely rests on the circuit board while the main body partially or entirely protrudes from the circuit board when the signal connector has been coupled to the circuit board.

2. The signal connector according to claim 1 wherein the circuit board has a recess from an edge thereof for receiving a front section of the main body, and the coupling member laterally and forwardly extends from the front section of the main body to be surface-mounted onto the circuit board beside the recess.

3. The signal connector according to claim 1 wherein the coupling member is an arc-shaped structure protruding from the front surface of the main body and having two end teeth for engaging with two through holes of the circuit board, respectively.

4. The signal connector according to claim 1 wherein the coupling member is a gate-shaped structure protruding from the front surface of the main body and having two end teeth for engaging with two through holes of the circuit board, respectively.

5. The signal connector according to claim 1 wherein the main body includes a jack having therein a signal line structure, and the signal line structure has one end to be electrically connected to the external signal connector and the other end to be inserted into an additional through hole of the circuit board, thereby conducting the external signal connector with the circuit board.

6. The signal connector according to claim 5 wherein the main body further includes a grounding shell structure surrounding the signal line structure and separate from the signal line structure with an insulating spacer plate.

7. The signal connector according to claim 6 wherein the coupling member is electrically insulated from the signal line structure by way of the insulating spacer plate.

8. The signal connector according to claim 7 wherein the coupling member is integrally formed with the grounding shell structure of the main body.

9. The signal connector according to claim 1 wherein the coupling member extends from the front surface of the main body in a first direction substantially normal to the front surface, and the free end of the coupling member turns into a second direction in substantially parallel to the front surface of the main body.

10. The signal connector according to claim 9 wherein a width of the coupling member is smaller than that of the front surface in the second direction.

11. The signal connector according to claim 1 being an audio/video signal or a coaxial cable connector.
